(19) United States
(12) Patent Application Publication
(10) Pub. No.: US 2018/0267488 A1
(43) Pub. Date: Sep. 20, 2018

(54) CONTROL DEVICE AND OPERATING METHOD

(71) Applicants: INVENTEC (PUDONG) TECHNOLOGY CORP., Shanghai (CN); INVENTEC CORPORATION, Taiwan (CN)

(72) Inventor: Sheng-Hsin LO, Taiwan (CN)

(21) Appl. No.: 15/760,227

(22) PCT Filed: Mar. 25, 2016
(86) PCT No.: PCT/CN2016/077352

§ 371 Date: Mar. 14, 2018

(30) Foreign Application Priority Data
Nov. 26, 2015 (CN) 201510844168.5

(51) Int. Cl. G05B 15/02; G06F 17/30; G06K 19/06

(52) U.S. Cl. CPC G05B 15/02; G06F 17/30861; G05B 2219/2642; G06K 19/06028; G06K 19/06037

(57) ABSTRACT

A control device includes a picture generation module, an identification module, and a downloading module. The picture generation module is used for generating a panoramic picture, wherein the panoramic picture corresponds to a scene and contains a product. The identification module is used for identifying product data of the product. The downloading module is used for searching for a control program in a cloud server and downloading the control program to control the product according to the product data. The control device and an operating method therefor can control household appliances supporting different communication protocols by means of panoramic pictures.

### RELATED APPLICATIONS

This application is a continuation of International application No. PCT/CN2016/077352, filed on Mar. 25, 2016 which claims the benefits of priority of CN application No. 201510844168.5, filed on Nov. 26, 2015, the content of which are incorporated herein by reference.

### BACKGROUND

### Technical Field

The present disclosure relates to a control device and an operating method thereof. More particularly, the present disclosure relates to a control device and an operating method thereof which utilize a panoramic picture to control household appliances.

### Description of Related Art

Various household appliances can be controlled by cell phones on the current market. In general, control programs of the household appliances are downloaded and installed into the cell phones, and the control programs are performed to control the household appliances. However, support interfaces of household appliances of different manufacturers or different brands may be different. Some household appliances support WIFI. Some household appliances support Bluetooth or ZIGBEE. The Bluetooth interface is applied to short distance control. When users are at a long distance location (for example, a school or an office which is far away from home), it is unable to control the household appliances through Bluetooth interface. Under this condition, it is only able to control the household appliances through WIFI. The household appliances which support ZIGBEE interface are unable to be controlled through WIFI.

### SUMMARY

Based on the problems mentioned above, an objection of the present disclosure is to provide a control device and an operating method thereof which utilize a panoramic picture to control household appliances.

One embodiment of the present disclosure is related to a control device. The control device includes a picture generation module, an identification module, and a downloading module. The picture generation module is configured to generate a panoramic picture. The panoramic picture corresponds to a scene and contains at least one product. The identification module identifies product data for a tag identification code (for example, a Barcode, a QR code) of the at least one product. The downloading module is configured to search a control program in a cloud server and download the control program according to the product data to control the at least one product.

Another embodiment of the present disclosure is related to an operating method of a control device. The operating method includes: generating a panoramic picture, wherein the panoramic picture corresponds to a scene and contains at least one product; identifying product data for the at least one product; and searching a control program in a cloud server and downloading the control program from the cloud server according to the product data to control the at least one product.

As described above, the control device and the operating method thereof provided in the present disclosure utilize the panoramic picture to control household appliances supporting different communication protocols.

### BRIEF DESCRIPTION OF THE DRAWINGS

The disclosure can be more fully understood by reading the following detailed description of the embodiment, with reference made to the accompanying drawings as follows:

FIG. 1 is a schematic diagram illustrating a control device according to an embodiment of the present disclosure.

FIG. 2 is a block diagram illustrating a control device according to an embodiment of the present disclosure.

FIG. 3 is a flow diagram illustrating an operating method of a control device according to an embodiment of the present disclosure.

FIG. 4 is a schematic diagram illustrating a panoramic picture according to an embodiment of the present disclosure.

FIG. 5 is a schematic diagram illustrating tag contents according to an embodiment of the present disclosure.

FIG. 6 is a schematic diagram illustrating a stereoscopic picture of a household appliance according to an embodiment of the present disclosure.

### DETAILED DESCRIPTION

Hereinafter, an embodiment of the present disclosure by certain specific examples, those skilled in the art disclosed in this specification may readily understand the content of other advantages and effects of the present disclosure. The present disclosure may also be implemented or applied through other different specific embodiments, the details of the specification may be carried out in various modified or changed without departing from the spirit of the present disclosure based on various concepts and applications. It is noted that, in the case of no conflict, the embodiments and the features in the embodiments may be combined with each other.

It should be noted that the illustrated embodiment merely illustrative examples provided in the following examples to illustrate the basic idea of the present disclosure, then the drawings shows only related to the present disclosure, the number of components in the assembly when not in accordance with the actual embodiment, the shape and drawn to scale, its actual implementation of each component type, number and proportion of changes may be as a free, and the layout of the components may also be more complex patterns.

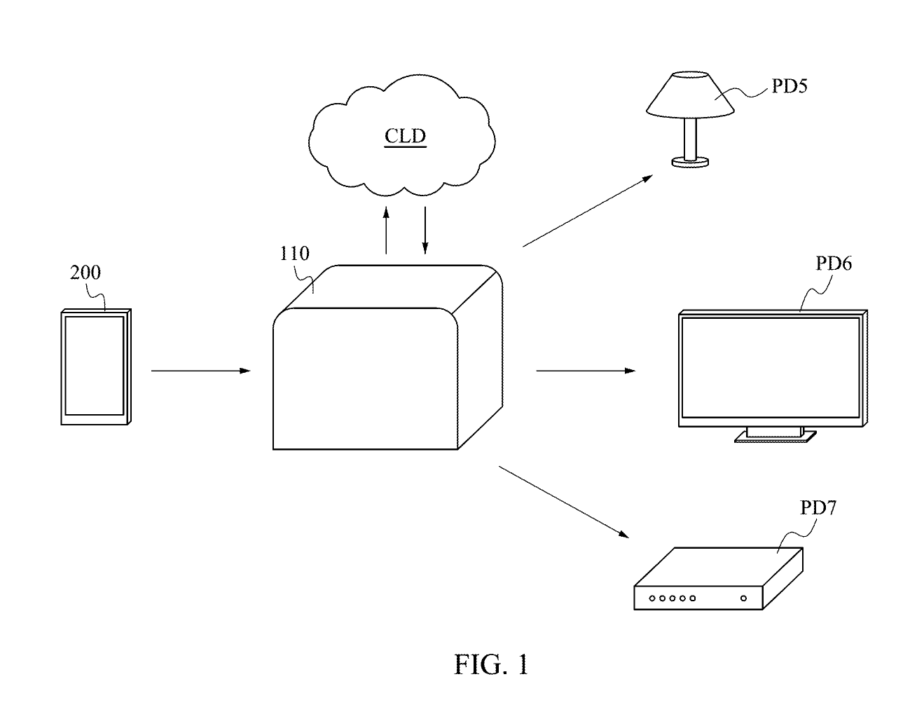

FIG. 1 is a schematic diagram illustrating a control device 110 configured to control household appliances according to an embodiment of the present disclosure. In generally, there are many household appliances in a home environment. As illustratively shown in FIG. 1, there are 3 household appliances PD5, PD6, and PD7. In practice, there may be more different household appliances that are not shown in FIG. 1 in the home environment. The different household appliances have different control interfaces and corresponding control programs.

The control device 110 is configured to generate a panoramic picture of the home environment and identify product data associated with a household appliance through a tag identification code (for example, a Barcode, QR code) in the panoramic picture. The control device 110 is further configured to, according to the product data, search and download a control program corresponding to the household appliance in a cloud server CLD in a wireless communication manner. A user utilizes a mobile device 200, such that the mobile device 200 is wirelessly connected to the control device 110 and sends a control message to the downloaded control program to drive the control program. At this time, the control program controls the corresponding household appliance PD1, PD2, or PD3 in the wireless communication manner. The detail descriptions about how to identify the product data in the panoramic picture and how to search the control program in the cloud server according to the product data are described in following paragraphs.

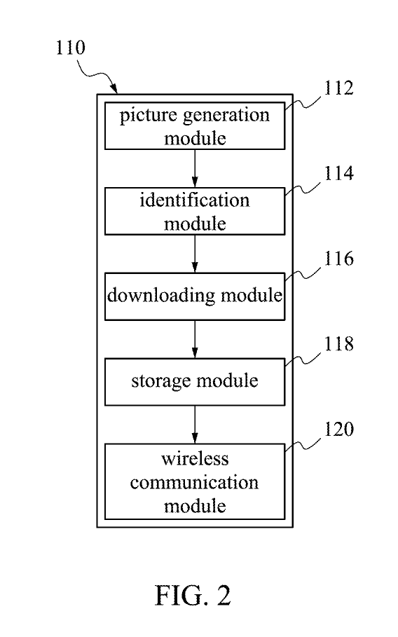

Reference is also made to FIG. 2. FIG. 2 is a block diagram illustrating the control device 110 according to an embodiment of the present disclosure. A picture generation module 112 is configured to generate a panoramic picture. The panoramic picture corresponds to a scene and contains a plurality of household appliances (household products). In some embodiments, the scene is usually an indoor space and a plurality of household appliances is in the indoor space. The indoor space is, for example, a living room, a bedroom, or a kitchen, but the present disclosure is not limited thereto. The household appliance contained in the panoramic picture is, for example, a TV, an air conditioner, a fan, a table lamp, a dehumidifier, or a refrigerator, but the present disclosure is not limited thereto.

In some embodiments, a form of the panoramic picture may be a 2D planar picture. In some other embodiments, the panoramic picture may be present by a 3D stereoscopic picture.

An identification module 114 is configured to identify the product data from the panoramic picture. In some embodiments, the product data identified is a 2D bar code having a specific form and disposed on the household appliance. The 2D bar code is, for example, a QR Code or a barcode. In some other embodiments, the product data is picture properties contained in the household appliance in the 3D stereoscopic picture. The picture properties are, for example, a size, a color, a shape, a frame, or a vein.

A downloading module 116 searches the control program corresponding to the household appliance in the cloud server CLD according to the product data. The cloud server CLD stores control programs corresponding to different household appliances. The different household appliances are, for example, a smart TV, a smart video player, a smart air conditioner, a smart refrigerator, or a smart standing lights

A storage module 118 is configured to store the control program downloaded by the downloading module 116. The wireless communication module 120 wirelessly communicates with the mobile device 200 and makes the mobile device 200 to drive the control program in the storage module 118 to control the household appliance. In some embodiments, the mobile device 200 is a smart phone, a tablet computer (a tablet), a notebook, or various portable devices with wireless communication function.

In some embodiments, wireless communication is a short distance or a long distance wireless communication technology based on WIFI, Bluetooth, or ZIGBEE, but the present disclosure is not limited thereto.

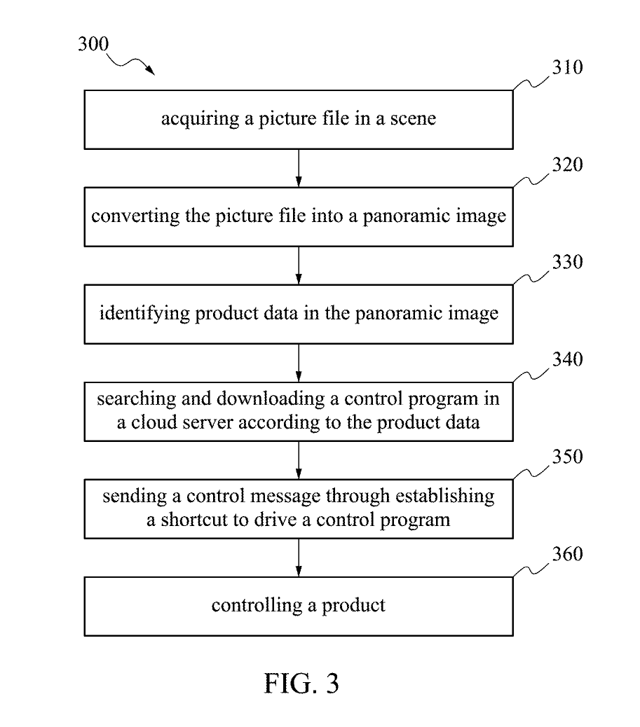

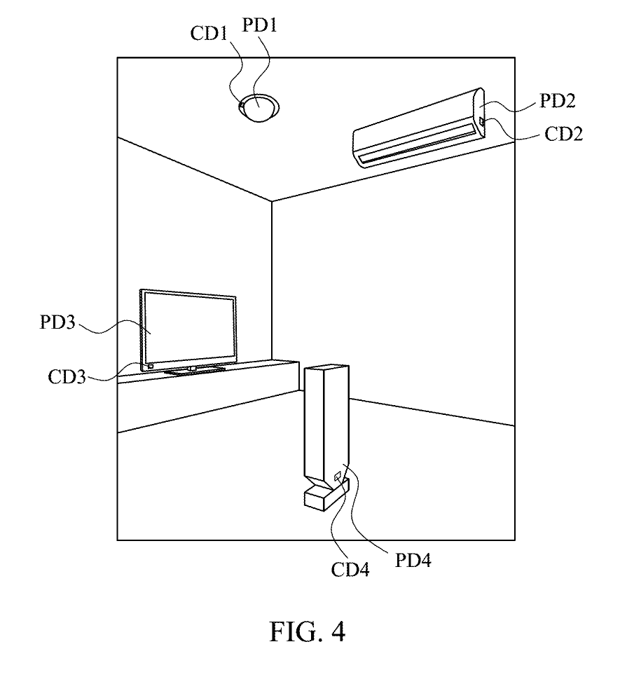

Reference is now made to FIGS. 3 and 4 that are a flow diagram illustrating an operating method 300 of the control device 110 according to an embodiment of the present disclosure and a schematic diagram illustrating a panoramic picture according to an embodiment of the present disclosure. In step 310, the control device 110 is arranged in an indoor scene. The picture generation module 112 of the control device 110 converts a picture file into a panoramic picture corresponding to a scene, as illustrated in FIG. 4. The picture file is acquired in an indoor scene and corresponding to the indoor scene.

In one embodiment, the method of acquiring the picture file corresponding to the indoor scene is to utilize a handheld device with CCD function to shoot the indoor scene, and thereby acquire the picture file corresponding to the indoor scene. At this time, the picture generation module 112 converts the received picture file into a 2D panoramic picture.

In another embodiment, the method of acquiring the picture file corresponding to the indoor scene is to utilize a 3D camera to shoot the indoor scene, in order to acquire the picture file of the indoor scene. In another embodiment, a laser which may measure distances is used to detect targets and scan surrounding of the indoor scene in a manner of point scan, in order to acquire the picture file of the indoor scene. Then, the picture generation module 112 converts the picture file into a panoramic picture corresponding to the scene picture. The panoramic picture and the household appliances contained in the panoramic picture are present by a 3D stereoscopic manner.

As illustrated in FIG. 4, a panoramic picture 500 includes household appliances PD1, PD2, PD3, and PD4 contained in the indoor scene. Each of the household appliances has corresponding product data. In step 330, the identification module 114 identifies the product data of each of the household appliances in the panoramic picture generated by the picture generation module 112.

In one embodiment, the product data identified by the identification module 114 is a tag. As described above, the tag may be a common RQ Code, a common barcode, or a common 2D bar code with a specific form on the household appliances.

The tag discussed above is usually disposed on each of the household appliances by pasting, engraving, or other manners. As illustrated in FIG. 4, the household appliance PD1 is a smart light, and a corresponding tag CD1 is disposed on the household appliance PD1. Similarly, the household appliance PD2 is a smart air conditioner, and a corresponding tag CD2 is disposed on the household appliance PD2. The household appliance PD3 is a smart TV, and a corresponding tag CD3 is disposed on the household appliance PD3. The household appliance PD4 is a smart fan, and a corresponding tag CD4 is disposed on the household appliance PD4.

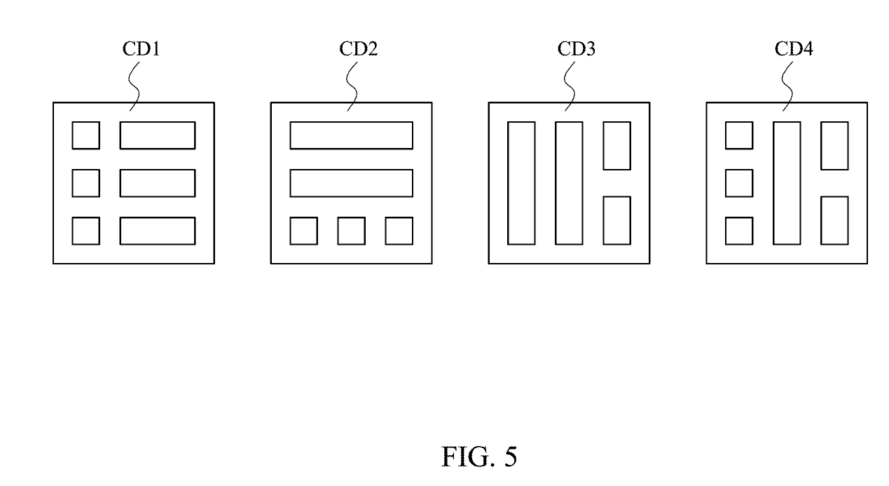

Reference is also made to FIG. 5. FIG. 5 is a schematic diagram illustrating tag contents of tags CD1-CD4 according to an embodiment of the present disclosure. Each of the tag contents has its specific content including, for example, a bar code, a block arrangement, numbers, or various forms. These tags include URLs or download links of specific manufacturers which manufacture the household appliances. As illustrated in FIG. 5, the tags CD1-CD4 corresponding to the household appliances PD1-PD4 have different block arrangements. URLs of the manufacturers or links for downloading control programs of the household appliances PD1-PD4 may be searched through the different block arrangements.

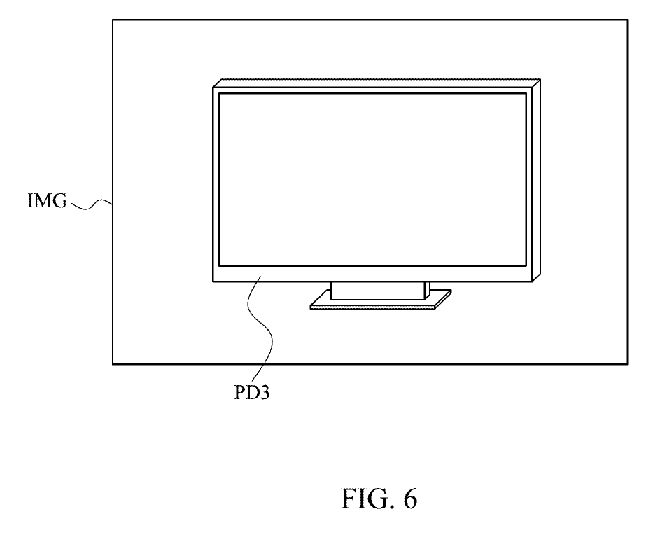

In another embodiment, the product data identified by the identification module 114 is picture properties contained in the household appliances in the 3D stereoscopic picture. The picture properties are sizes, colors, shapes, frames, or veins of the household appliances. Reference is also now made to FIG. 6 that is a schematic diagram illustrating a stereoscopic picture IMG of the household appliance PD3 according to an embodiment of the present disclosure. From FIG. 6, the picture properties of the household appliance PD3 are, for example, a shape which is similar with a rectangle, a support object which is below the shape and has a smaller cylinder shape, and a flatten object to be as a base.

When the identification module 114 identifies the product data of corresponding household appliances, in step 340, the downloading module 116 searches and downloads one or more control programs corresponding to the household appliances in the cloud server CLD according to the identified product data.

In one embodiment, the downloading module 116 performs searching and downloading of the control programs in the cloud server CLD according to the tag content of each of the household appliances. For example, the specific tag content of the tag CD1 corresponding to the household appliance PD1 is three regular triangles on the left with three bar-shape blocks. The downloading module 116, by scanning the specific tag content, searches related information corresponding to the content in the cloud server CLD. The related information includes the control program which is configured to control the household appliance PD1.

Accordingly, the downloading module 116, by scanning the specific tag contents of the tag CD2-CD4 of the household appliances PD2-PD4, searches related information corresponding to the tag contents in the cloud server CLD. The related information includes one or more control programs which are configured to control the household appliances PD2-PD4. The identification methods of the tags are well known to the person skilled in the art, so it is not described herein.

In another embodiment, the downloading module 116, by picture properties contained in the household appliances in the 3D stereoscopic picture, searches related information corresponding to the picture properties in the cloud server CLD. The related information includes one or more control programs which are configured to control the household appliances PD1-PD4. In other words, the control programs of the household appliances which are satisfied with the picture properties are searched in the cloud server CLD and are downloaded.

In step 340, when the downloading module 116 searches, in the cloud server CLD, the control program which the downloading module 116 wants to search, the control program is downloaded into the storage module 118 of the control device 110.

At this time, in step 350, a user may establish a shortcut (not shown) on the mobile device 200. The shortcut is a bottom on an interface of the mobile device 200, and the shortcut is configured to communicate with the control device 110. When the user clicks the shortcut, the mobile device 200 may be connected to the wireless communication module 120 of the control device 110 in the wireless communication manner. Further, the mobile device 200 is connected to various control programs downloaded in the storage module 118, and the control programs are driven by sending one or more control messages.

In step 360, the user may drive the control programs in the storage module 118 by the shortcut established in the mobile device 200, in order to control the household appliances corresponding to the control programs. Different household appliances correspond to different control programs. Various controls are performed to the different household appliances by the different control programs. For example, when a control program of the household appliance PD1 (for example, a smart light) stored in the storage module 118 is connected through the shortcut, the user may control the household appliance PD1. The control is, for example, switching a switch or adjusting brightness.

When a control program of the household appliance PD2 (for example, a smart air conditioner) stored in the storage module 118 is connected through the shortcut, the user may control the household appliance PD2. The control is, for example, switching a switch, adjusting a wind speed, adjusting a temperature, or setting a sleeping mode.

When a control program of the household appliance PD3 (for example, a smart TV) stored in the storage module 118 is connected through the shortcut, the user may control the household appliance PD3. The detailed controls are, for example, switching a switch, adjusting volume, changing a channel, or setting time to record a favorite show.

When a control program of the household appliance PD4 (for example, a smart fan) stored in the storage module 118 is connected through the shortcut, the user may control the household appliance PD4. The control is, for example, switching a switch, adjusting a wind speed of the smart fan, or adjusting a rotating direction of the smart fan.

The identified product data in the aforementioned embodiments has concrete identification contents (for example, the tags or the picture properties). However, in some embodiments, the product data of some household appliances do not have any concrete content. Under this condition, the downloading module is unable to perform searching in the cloud server according to the product data.

At this time, the user may directly perform selecting for the specific household appliances in the panoramic picture by a manual method, in order to perform setting about the controls discussed above.

As contents and embodiments discussed above, the control device includes the picture generation module configured to generate a panoramic picture including the household appliances. The identification module identifies the product data in the panoramic picture. The control program of a corresponding household appliance is searched in the cloud server according to the product data.

The embodiments above merely describe the principles and effectiveness of the present disclosure, but the present disclosure is not limited thereto. It will be apparent to those skilled in the art that various modifications and variations can be made to the structure of the present disclosure without departing from the scope or spirit of the present disclosure. In view of the foregoing, it is intended that the present disclosure cover modifications and variations of the present disclosure provided they fall within the scope of the following claims.

What is claimed is:

1. A control device, comprising:
a picture generation module configured to generate a panoramic picture, wherein the panoramic picture corresponds to a scene and contains at least one product;
an identification module electrically connected to the picture generation module, wherein the identification module identifies product data for the at least one product; and
a downloading module configured to search a control program in a cloud server and download the control program from the cloud server according to the product data, wherein the control program corresponds to the at least one product.

2. The control device of claim 1, wherein the control device further comprises:
a storage module electrically connected to the downloading module, wherein the storage module is configured to receive and store the control program; and
a wireless communication module electrically connected to the storage module, wherein the wireless communication module is configured to wirelessly communicate with a mobile device, such that the mobile device is wirelessly connected to the storage module and remotely controls the at least one product by the control program.

3. The control device of claim 1, wherein the product data identified by the identification module is a tag, which is contained in the panoramic picture, of the at least one product, and the downloading module searches the control program in the cloud server according to the tag.

4. The control device of claim 1, wherein the product data identified by the identification module is a stereoscopic picture, which is contained in the panoramic picture, of the at least one product, the stereoscopic picture comprises a plurality of picture properties, and the downloading module searches the control program in the cloud server according to the picture properties.

5. The control device of claim 4, wherein the picture properties included in the stereoscopic picture are at least one of a shape, a size, a color, a frame, or a vein of the at least one product.

6. An operating method, comprising following steps:
generating a panoramic picture, wherein the panoramic picture corresponds to a scene and contains at least one product;
identifying product data for the at least one product; and
searching a control program in a cloud server and downloading the control program from the cloud server according to the product data, wherein the control program corresponds to the at least one product.

7. The operating method of claim 6, further comprising following steps:
receiving and storing the control program; and
receiving a control message, wherein the control message is configured to drive the control program to remotely control the at least one product.

8. The operating method of claim 6, wherein downloading the control program comprises:
downloading the control program from the cloud server according to a tag when the product data is a tag.

9. The operating method of claim 6, wherein the product data is a stereoscopic picture, the stereoscopic picture contains a plurality of picture properties, and the control program is downloaded from the cloud server according to the picture properties, wherein the control program is configured to control the at least one product.

10. The operating method of claim 9, wherein the picture properties included in the stereoscopic picture are at least one of a shape, a size, a color, a frame, or a vein of the at least one product.
